(19) United States
(12) Patent Application Publication
(10) Pub. No.: US 2004/0049325 A1
(43) Pub. Date: Mar. 11, 2004

(54) Vehicle control system with selectable vehicle style image and associated methods

(75) Inventors: Kenneth E. Flick, Douglasville, GA (US); Michael Stephen Thompson, Douglasville, GA (US); Robert Loyd Drew, Bowdon, GA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Omega Patents, L.L.C., Douglasville, GA

(21) Appl. No.: 10/236,369

(22) Filed: Sep. 6, 2002

(51) Int. Cl. G06F 17/00

(52) U.S. Cl. 701/2; 701/36

(57) ABSTRACT

A remote control system for a vehicle includes a controller at the vehicle, and at least one remote device for wireless communication with the controller. The remote device may include a portable handheld housing, to be carried by a user when away from the vehicle, and a display, such as a Liquid Crystal Display (LCD), mounted on the portable housing for displaying a selected vehicle style image from among a plurality of different selectable vehicle style images. For example, the different selectable vehicle style images may include a sedan style image, a pickup truck style image, and a van style image. The LCD may include a common image portion for all of the different selectable vehicle style images, and at least one other defining image portion selectively operated together with the common image portion to display the selected vehicle style image.

### FIELD OF THE INVENTION

The present invention relates to the field of vehicle remote control systems, and, more particularly, to a vehicle remote control system including a display for displaying vehicle images.

### BACKGROUND OF THE INVENTION

Vehicle security systems are widely used to deter vehicle theft and perform various security-related vehicle functions. A typical vehicle security system includes a controller having a receiver connected thereto. The controller may perform security-related functions, such as locking/unlocking doors, operating windows, and/or switching between armed and disarmed modes responsive to signals received from one or more remote transmitters. When in the armed mode, the controller may generate an alarm indication at the vehicle responsive to a vehicle security sensor indicating a vehicle security breach. A remote transmitter is typically carried by the owner or user of the vehicle when away from the vehicle.

A vehicle remote control system may also be used for remote starting of the vehicle engine. This remote starting may be in addition to security related functions, or in lieu thereof.

Newer vehicle control systems are being developed and sold with two-way communications capability between the vehicle controller and the handheld remote device. For example, Crimestopper of Simi Valley, Calif. offers a model under the designation CS-2006FM that includes two-way communication. The remote device includes a liquid crystal display (LCD) that displays a vehicle image.

Along these lines, U.S. Pat. No. 5,940,007 to Brinkmeyer et al. discloses a remote device that displays an image of a vehicle. The remote device receives signals transmitted from the vehicle controller and indicates a vehicle security condition on the displayed vehicle image. For example, the transmitter may display a blacked-out portion of the vehicle image to indicate a break in.

Some vehicle security systems are adapted for multi-vehicle operation. More particularly, multiple vehicles may be operated using one remote transmitter or remote device. Controllers in each vehicle are responsive to only one signal bank from among different signal banks for different vehicles. An example, of such a high-quality, multi-vehicle security system is the Excalibur® 1800ATV offered by Omega Research and Development of Douglasville, Ga. The remote devices may be switched between signal banks to operate a desired vehicle. One shortcoming with these systems, however, is that it may be difficult for the user to determine which vehicle will be operated based upon the selected signal bank.

### SUMMARY OF THE INVENTION

In view of the foregoing background, it is therefore an object of the present invention to provide a remote control system for a vehicle that reduces the possibility of confusion for the vehicle to be controlled by the remote device.

This and other objects, features, and advantages of the present invention are provided by a vehicle remote control system including a controller at the vehicle, and at least one remote device for wireless communication with the controller. More particularly, the remote device may include a portable handheld housing, and a display, such as an LCD, for displaying a selected vehicle style image from among a plurality of different vehicle style images. The different vehicle style images may include a sedan style image, a pickup truck style image, and/or a van style image, for example. The LCD may comprise a common image portion for all of the different selectable vehicle style images, and at least one other defining image portion selectively operated together with the common image portion to display the selected vehicle style image. Accordingly, the user may personalize his remote device, the user's convenience is enhanced for multiple vehicle operation, and a relatively low cost LCD may be used.

The controller may perform at least one vehicle security function, and wherein the LCD may also display at least one vehicle security function image based upon the controller. In addition, the controller may perform at least one vehicle starting function, and the LCD may also display at least one vehicle starting function image based upon the controller.

The remote device may further comprise a processor for driving the LCD. The processor may be switchable to a selection mode for permitting user selection of the selected vehicle style image. In some embodiments, the processor may operate using a selected signal bank from among a plurality of signal banks for respective different vehicles. In these embodiments, the selected vehicle style image may be selected based upon the selected signal bank. In other words, if the user selects a different signal bank, the displayed vehicle style image also changes to the corresponding vehicle style image.

The LCD may further display alphanumeric indicia associated with the selected signal bank. More particularly, the LCD may display a license plate outline on the vehicle image surrounding the alphanumeric indicia. This additional display may be helpful to the user when at least some of the different vehicles to be controlled have the same vehicle style.

The controller may also transmit at least one signal to the remote device, and, this signal may be used to select the selected vehicle style image to correspond to a vehicle in which the controller is positioned. In other words, the selected vehicle style image may be changed from its current image to correspond with the vehicle style image of the vehicle from which an alarm indication is received.

The controller may comprise a first wireless transceiver, and the at least one remote device may comprise a second wireless transceiver for two-way communication with the first wireless transceiver. For example, frequency modulation (FM) is typically used for the two-way wireless transceivers. The at least one remote device may further include at least one of a tactile indicator, and an audible indicator carried by the portable housing. The remote device may also include a battery carried by the housing. In some embodiments, a display other than an LCD may be used, such as, for example, a plasma gas display.

A method aspect of the invention is for using a remote device for communicating with a controller at a vehicle as part of a remote control system for the vehicle. The remote device may comprise a portable handheld housing to be carried by a user when away from the vehicle, and a display mounted on the portable housing. The method may include selecting a selected vehicle style image from among a plurality of different selectable vehicle style images, and displaying the selected vehicle style image on the display.

### BRIEF DESCRIPTION OF THE DRAWINGS

FIG. 1 is a schematic block diagram of a vehicle remote control system according to the present invention.

FIG. 2 is a schematic block diagram of the remote device shown in FIG. 1.

FIG. 3 is a plan view of the LCD of the remote device as shown in FIG. 2 and illustrating the common image portion.

FIG. 4 is a plan view of the LCD of the remote device as shown in FIG. 2 and illustrating a sedan style vehicle image.

FIG. 5 is a plan view of the LCD of the remote device as shown in FIG. 2 and illustrating a pickup truck style vehicle image.

FIG. 6 is a plan view of the LCD of the remote device as shown in FIG. 2 and illustrating a van style vehicle image.

FIG. 7 is a plan view of the LCD of the remote device as shown in FIG. 2 and illustrating additional security and remote start images.

FIGS. 8-9 are flowcharts illustrating method aspects of the vehicle remote control system shown in FIG. 1.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers are used to refer to like elements throughout.

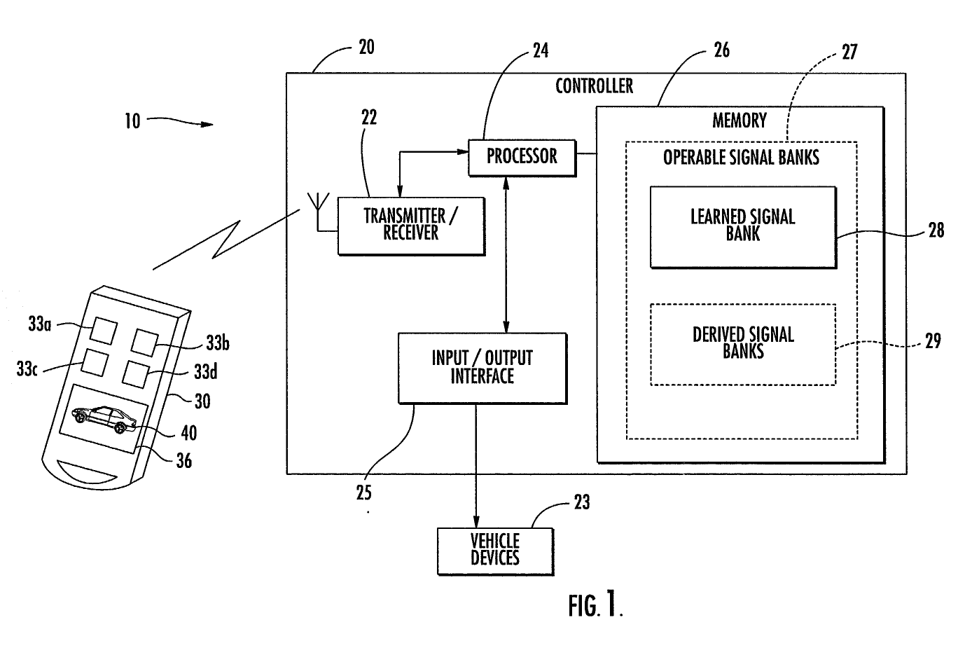

Referring initially to FIG. 1, a remote control system 10 for a vehicle is described. The remote control system 10 illustratively includes a controller 20 at the vehicle for receiving signals and performing vehicle functions. The remote control system 10 also illustratively includes at least one remote device 30 to be carried by a user. The controller 20 illustratively includes a transmitter and receiver, or transceiver, 22 for wirelessly transmitting and receiving vehicle signals to and from the remote device 30. The transceiver 22 may operate using frequencies and modulation schemes, such as frequency modulation, as are typically used for vehicle control systems.

The controller 20 further illustratively includes a processor 24 connected to the transceiver 22, and a memory 26 connected to the processor. It will be appreciated by those skilled in the art that the transmitter/receiver 22 may be provided within a common housing with the processor 24, as illustrated, or separately.

The memory 26 illustratively stores data related to a plurality of operable signal banks 27. The operable signal banks 27 may be learned signal banks 28 or derived signal banks 29 to allow operation of the controller responsive to signals from different remote devices 30, for example. The controller 20 further includes an input/output interface 25 connected to the processor 24 for interfacing vehicle devices 23 with the controller to allow vehicle functions to be performed. The vehicle devices may, for example, include vehicle door locks, vehicle windows, a vehicle trunk, vehicle security sensors, devices associated with remote starting the vehicle, etc., as will be readily appreciated by those skilled in the art. Considered in slightly different terms, the vehicle controller 20 may perform vehicle security functions, remote starting functions, or both types of functions, as will also be appreciated by those skilled in the art.

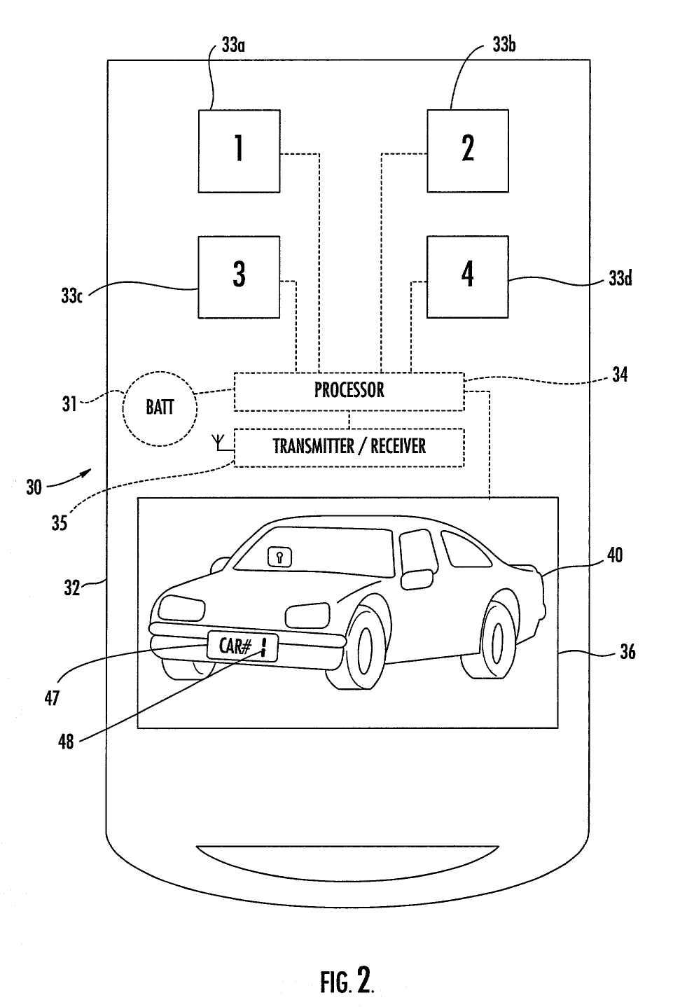

Turning now additionally to FIG. 2, the remote device 30 is now described in further detail. The remote device 30 illustratively includes a portable housing 32 and several switches 33a, 33b, 33c, 33d carried by the housing. A transmitter and receiver, or transceiver, 35 is also carried by the housing 32. The transmitter of the transceiver 35 is for transmitting remote control signals to the vehicle controller 20 based upon user operation of at least one of the switches 33a, 33b, 33c, 33d, for example. The receiver of the transceiver 35 is for receiving signals from the vehicle controller 20.

The remote device 30 also illustratively includes an LCD 36 for displaying a selected vehicle style image 40, for example, along with other security and/or remote start information. For example, the selected vehicle style image 40 may be from among a plurality of different vehicle style images such as a sedan style vehicle, van style vehicle, and/or a pickup style vehicle, as will be described in greater detail below. Those of skill in the art will appreciate that other vehicle style images are also contemplated by the present invention.

The remote device 30 also illustratively includes a processor 34 connected to the switches 33a, 33b, 33c, 33d, the transmitter/receiver 35 and the LCD 36. The processor 34 processes received signals, and performs other functions associated with driving the LCD 36 as will be appreciated by those skilled in the art. A battery 31 is also carried within the housing 32 and connected to the processor 34 to provide power thereto.

In one class of embodiments, the processor 34 of the remote device 30 is switchable to a selecting mode for permitting user selection of the selected vehicle image 40, such as by predetermined operation of one or more of the switches 33a, 33b, 33c, 33d. Accordingly, a user may customize his remote device for his particular style of vehicle. This may be especially beneficial where the household includes several vehicles of different styles, and multiple such remote devices are used by different household members.

The remote transmitter 30 may also be selectively operable using a selected signal bank 27 from among a plurality of signal banks for different vehicles. In these embodiments, the processor 34 selects the selected vehicle type image based upon the selected signal bank. Of course, vehicle style images can be selected or programmed for each different signal bank as will be appreciated by those skilled in the art. Accordingly, the remote device 30 displays on its LCD 36 a corresponding vehicle image 40 for the selected signal bank 27.

The LCD 36 may further display alphanumeric indicia 48 associated with the selected signal bank. More particularly, the LCD 36 may display a license plate outline 47 on the vehicle image surrounding the alphanumeric indicia 48. This additional display may be helpful to the user when at least some of the different vehicles to be controlled have the same vehicle style.

The controller 20 may also transmit at least one signal to the remote device 30, and, this signal may be used to select the selected vehicle style image 40 to correspond to a vehicle in which the controller is positioned. In other words, the selected vehicle style image 40 may be changed from its current image to correspond with the vehicle style image of the vehicle from which an alarm indication is received for the user's convenience.

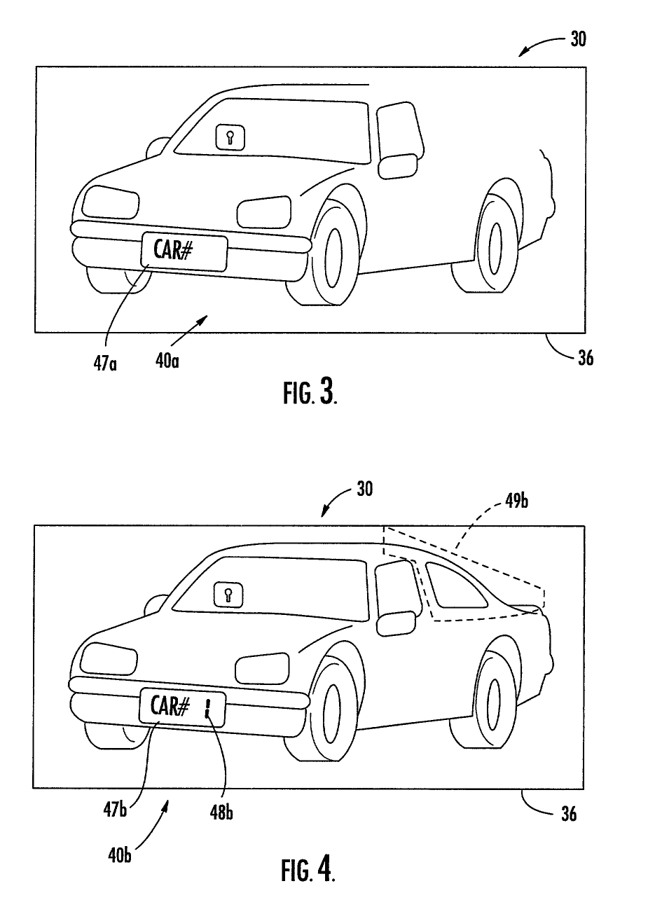

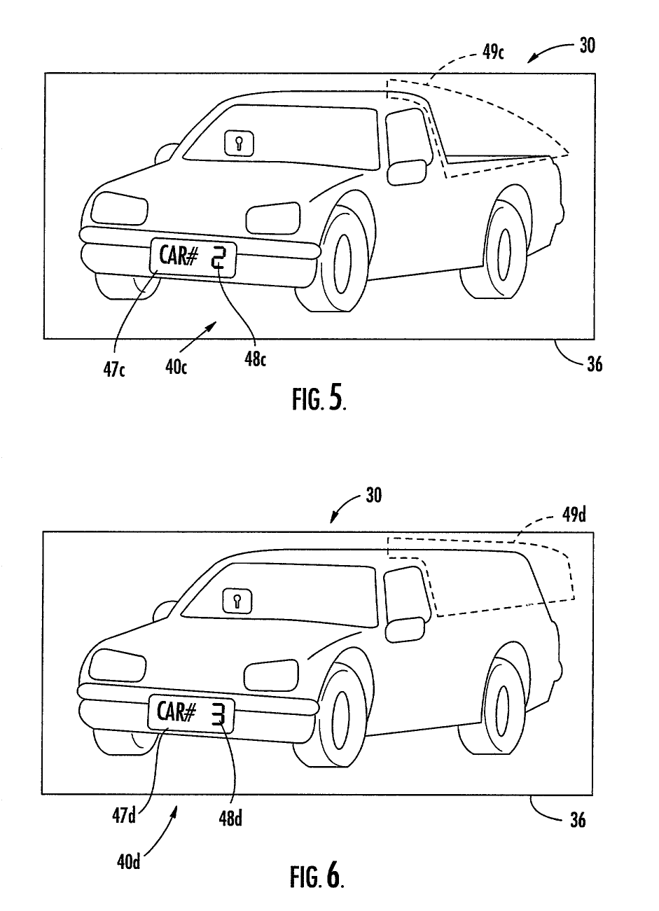

Turning now additionally to FIGS. 3-6, exemplary vehicle style images 40 as may be used by the LCD 36 are now further described. The vehicle image 40 is illustratively one of a sedan style image 40b (FIG. 4), a pickup truck style image 40c (FIG. 5), a van style image 40d, or any other type of vehicle style image as understood by those skilled in the art. For example, a hatchback image could also be displayed as will be appreciated by those skilled in the art.

A common image portion 40a (FIG. 3) is commonly operated for all of the vehicle images 40b-40d. For example, the common image portion 40a can be a single pattern in the LCD 36 as designed and manufactured, as will be appreciated by those skilled in the art. The other vehicle style images 40b-40d include respective defining image portions selectively operated together with the common image portion 40a to display the selected vehicle style image. For example, the sedan style image 40b includes the rear window, rear roof, and trunk defining image portions within the dashed box 49 (FIG. 4). Likewise, in FIG. 5, the defining image portions 49c form the back window and truck bed enclosed within the dashed box 49c. In FIG. 6 the image defining portions form the rear cargo or passenger area within box 49d. Of course, the van style image 40d is also similar to an SUV style image and can also be used for an SUV.

As also shown in FIG. 3 the common image portion 40a may also include a license plate outline 47a so that each vehicle style image 40b-40d may further include an alphanumeric indicia 48b-48d, such as the illustrated numbers 1 through 3, surrounded by the license plate outline 47b-47d. This additional display may be especially helpful to the user when at least some of the different vehicles to be controlled have the same vehicle style. As noted above, the controller 20 may also transmit at least one signal to the remote device 30, and, this signal may be used to select the selected vehicle style image as well as the corresponding alphanumeric indicia to correspond to a vehicle in which the controller is positioned.

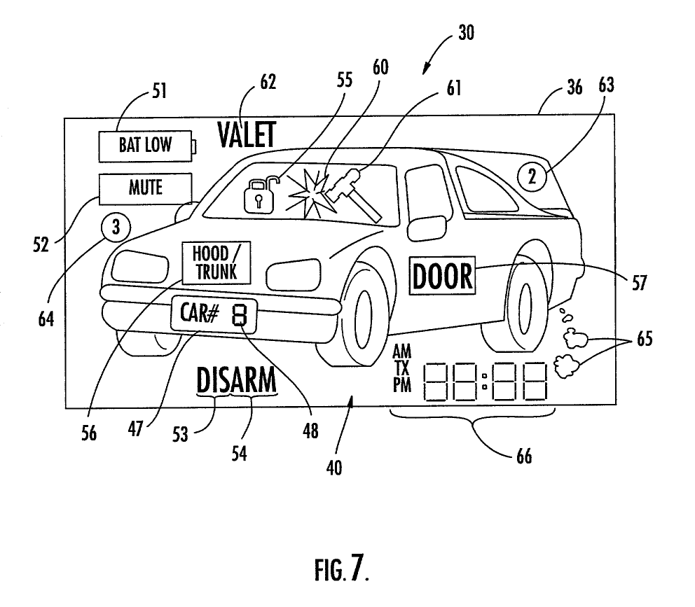

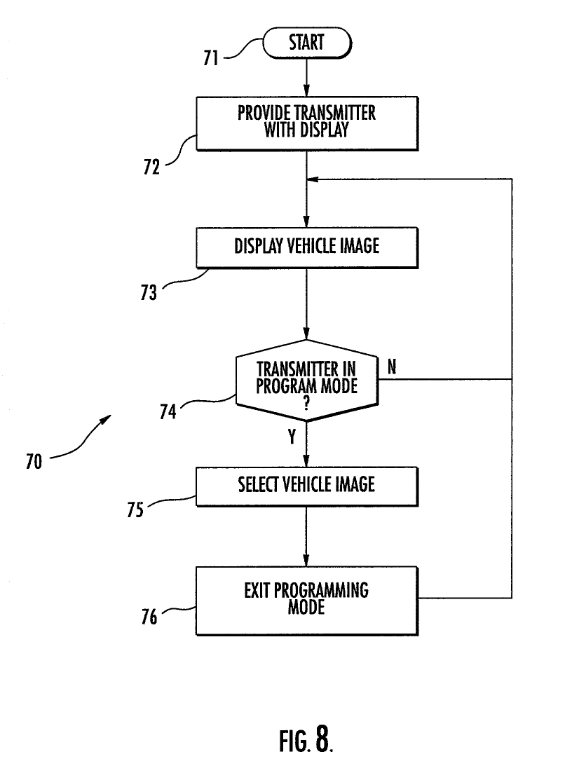

Referring now additionally to FIG. 7, additional aspects of the remote device 30 and its LCD display 36 are now described. In particular, the LCD 36 may display information relating to security and/or remote starting of the vehicle. For example, indications illustratively include a low battery indication 51, a mute indication for indicating whether the vibration alert or chirp alert is selected, phrases “DIS” 53 and “ARM” 54 for indicating armed or disarmed status, a door lock and unlock image 55, a hood/trunk zone violated image 56, a door zone violated image 57, a shock sensor image 60, a hammer image indicating the violated zone 61, a valet image 62 for the valet mode being selected, a channel two 63 and a channel three 64 image, an exhaust image 65 indicating the vehicle has started, and a four digit image 66.

A pager feature may also be provided wherein a switch in the vehicle and connected to the controller 20 is used to cause the remote device 30 to issue a tactile (vibration) or audible paging alert as will be appreciated by those skilled in the art. Many other convenience and/or security type features are also contemplated by the present invention as will be appreciated by those skilled in the art.

The four digit image 66 may be used to display the time, for example. Also the four digit image 66 can display the number of remote devices learned into the controller for additional security. This remote transmitter verification feature is further described, for example, in U.S. Pat. Nos. 5,654,688 and 6,140,938, the entire disclosures of which are incorporated herein by reference. Those of skill in the art will appreciate that other vehicle information may also be determined and displayed on the LCD 36.

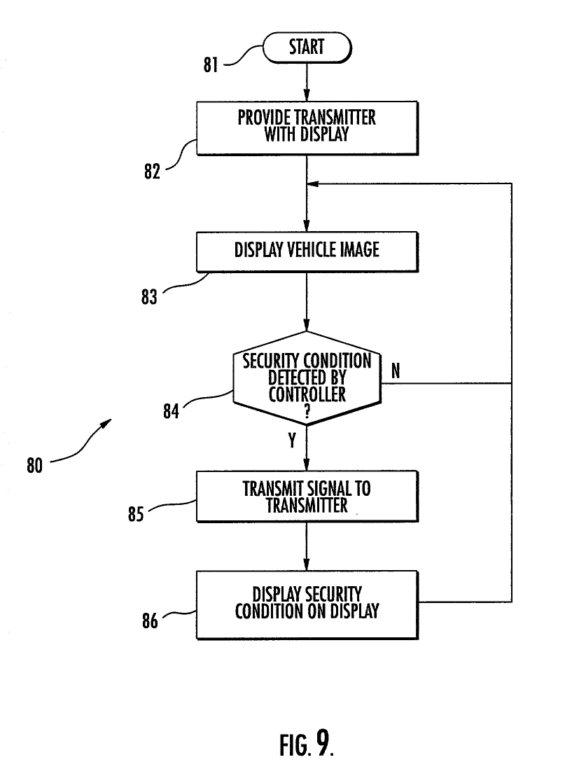

Turning now additionally to the flow chart 70 of FIG. 8, a method aspect of the invention is now described. From the start (Block 71), a remote device 30 is provided at Block 72. At Block 73 a vehicle style image 40 is displayed. At Block 74, it is determined whether or not the remote device 30 is in a programming mode. If so, a vehicle style image 40 is selected from among a plurality of vehicle style images at Block 75. If, however, it is determined at Block 74 that the remote device 30 is not in the programming mode, the remote device continues to display the vehicle style image 40 at Block 73. At Block 76, the programming mode is exited.

Turning now additionally to the flow chart 80 of FIG. 9, another method aspect of the present invention is now described. From the start (Block 81) a remote device 30 including a display 36 is provided. At Block 83, a vehicle style image 40 is displayed. At Block 84, it is determined whether a security condition has been detected by the controller 20. If so, the controller 20 transmits a signal to the remote device 30 at Block 85. If no security condition is detected at Block 84, the remote device 30 continues to display the vehicle style image 40 at Block 83. At Block 86, the security condition is displayed.

Other features relating to vehicle remote control systems such as for multiple vehicles are disclosed in a co-pending patent application entitled VEHICLE REMOTE CONTROL SYSTEM FOR MULTIPLE OR SINGLE VEHICLE OPERATION AND ASSOCIATED METHODS, filed Jul. 2, 2002 Ser. No. 10/188,440 the entire disclosure of which is incorporated herein by reference.

Although an LCD display has been described herein for illustration purposes, in other embodiments of the remote device 20, other types of displays may also be used, such as, for example, a plasma display as will be appreciated by those skilled in the art. Accordingly, many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that other modifications and embodiments are intended to be included within the scope of the appended claims.

That which is claimed is:

1. A vehicle remote control system comprising:
a controller at the vehicle and at least one remote device for wireless communication therewith, said at least one remote device comprising
a portable handheld housing to be carried by a user when away from the vehicle, and
a Liquid Crystal Display (LCD) mounted on said portable housing for displaying a selected vehicle style image from among a plurality of different selectable vehicle style images.

2. A remote control system according to claim 1 wherein the different selectable vehicle style images comprise at least two of a sedan style image, a pickup truck style image, and a van style image.

3. A remote control system according to claim 1 wherein said LCD comprises a common image portion for all of the different selectable vehicle style images, and at least one other defining image portion selectively operated together with the common image portion to display the selected vehicle style image.

4. A remote control system according to claim 1 wherein said controller performs at least one vehicle security function; and wherein said LCD is also for displaying at least one vehicle security function image based upon said controller.

5. A remote control system according to claim 1 wherein said controller performs at least one vehicle starting function; and wherein said LCD is also for displaying at least one vehicle starting function 5 image based upon said controller.

6. A remote control system according to claim 1 wherein said at least one remote device further comprises a processor for driving said LCD.

7. A remote control system according to claim 6 wherein said processor is switchable to a selection mode for permitting user selection of the selected vehicle style image.

8. A remote control system according to claim 6 wherein said processor operates using a selected signal bank from among a plurality of signal banks for respective different vehicles.

9. A remote control system according to claim 8 wherein the selected vehicle style image is selected based upon the selected signal bank.

10. A remote control system according to claim 8 wherein said LCD further displays alphanumeric indicia associated with the selected signal bank.

11. A remote control system according to claim 10 wherein said LCD further displays a license plate outline on the vehicle image surrounding the alphanumeric indicia.

12. A remote control system according to claim 8 wherein said controller transmits at least one signal to said at least one remote device which selects the selected vehicle style image to correspond to a vehicle in which said controller is positioned.

13. A remote control system according to claim 1 wherein said controller comprises a first wireless transceiver, and said at least one remote device comprises a second wireless transceiver for two-way communication with said first wireless transceiver.

14. A remote control system according to claim 1 wherein said at least one remote device further comprises at least one of a tactile indicator, and an audible indicator carried by said portable housing.

15. A remote control system according to claim 1 wherein said remote device further comprises a battery carried by said housing.

16. A vehicle remote control system comprising:
a controller at the vehicle and at least one remote device for wireless communication therewith, said at least one remote device comprising
a portable handheld housing to be carried by a user when away from the vehicle,
a Liquid Crystal Display (LCD) mounted on said portable housing for displaying a selected vehicle style image from among a plurality of different selectable vehicle style images, said LCD comprising a common image portion for all of the different selectable vehicle style images and at least one other defining image portion 15 selectively operated together with the common image portion to display the selected vehicle style image, and
a processor for driving said LCD.

17. A remote control system according to claim 16 wherein the different selectable vehicle style images comprise at least two of a sedan style image, a pickup truck style image, and a van style image.

18. A remote control system according to claim 16 wherein said controller performs at least one vehicle security function; and wherein said LCD is also for displaying at least one vehicle security function image based upon said controller.

19. A remote control system according to claim 16 wherein said controller performs at least one vehicle starting function; and wherein said LCD is also for displaying at least one vehicle starting function image based upon said controller.

20. A remote control system according to claim 16 wherein said processor is switchable to a selection mode for permitting user selection of the selected vehicle style image.

21. A remote control system according to claim 16 wherein said processor operates using a selected signal bank from among a plurality of signal banks for respective different vehicles.

22. A remote control system according to claim 21 wherein the selected vehicle style image is selected based upon the selected signal bank.

23. A remote control system according to claim 21 wherein said controller transmits at least one signal to said at least one remote device which selects the selected vehicle style image to correspond to a vehicle in which said controller is positioned.

24. A remote control system according to claim 16 wherein said controller comprises a first wireless transceiver, and said at least one remote device comprises a second wireless transceiver for two-way communication with said first wireless transceiver.

25. A remote device for communicating with a controller at a vehicle as part of a remote control system for the vehicle, the remote device comprising:
a portable handheld housing to be carried by a user when away from the vehicle; and
a display mounted on said portable housing for displaying a selected vehicle style image from among a plurality of different selectable vehicle style images.

26. A remote device according to claim 25 wherein the different selectable vehicle style images comprise at least two of a sedan style image, a pickup truck style image, and a van style image.

27. A remote device according to claim 25 wherein said display comprises a liquid crystal display (LCD).

28. A remote device according to claim 27 wherein said LCD comprises a common image portion for all of the different selectable vehicle style images, and at least one other defining image portion selectively operated together with the common image portion to display the selected vehicle style image.

29. A remote device according to claim 25 wherein said display is also for displaying at least one of a vehicle security function image, and a vehicle starting function image.

30. A remote device according to claim 25 wherein said at least one remote device further comprises a processor for driving said display.

31. A remote device according to claim 30 wherein said processor is switchable to a selection mode for permitting user selection of the selected vehicle style image.

32. A remote device according to claim 30 wherein said processor operates using a selected signal bank from among a plurality of signal banks for respective different vehicles.

33. A remote device according to claim 32 wherein the selected vehicle style image is selected based upon the selected signal bank.

34. A remote device according to claim 32 wherein said display further displays alphanumeric indicia associated with the selected signal bank.

35. A remote device according to claim 25 further comprising a wireless transceiver carried by said portable housing.

36. A remote device according to claim 25 further comprising at least one of a tactile indicator, and an audible indicator carried by said portable housing.

37. A remote device according to claim 25 further comprising a battery carried by said housing.

38. A method of using a remote device for communicating with a controller at a vehicle as part of a remote control system for the vehicle, the remote device comprising a portable handheld housing to be carried by a user when away from the vehicle, and a display mounted on the portable housing, the method comprising:
selecting a selected vehicle style image from among a plurality of different selectable vehicle style images; and
displaying the selected vehicle style image on the display.

39. A method according to claim 38 wherein the different selectable vehicle style images comprise at least two of a sedan style image, a pickup truck style image, and a van style image.

40. A method according to claim 38 wherein the display comprises a Liquid Crystal Display (LCD).

41. A method according to claim 40 wherein the LCD comprises a common image portion for all of the different selectable vehicle style images, and wherein selecting comprises selectively operating at least one other defining image portion together with the common image portion to display the selected vehicle style image.

42. A method according to claim 38 wherein the controller performs at least one vehicle security function; and further comprising displaying on the display at least one vehicle security function image based upon the controller.

43. A method according to claim 38 wherein the controller performs at least one vehicle starting function; and further comprising displaying on the display at least one vehicle starting function image based upon the controller.

44. A method according to claim 38 wherein the remote device further comprises a processor for driving the display.

45. A method according to claim 44 further comprising switching the processor to a selection mode for permitting user selection of the selected vehicle style image.

46. A method according to claim 44 further comprising operating the processor to use a selected signal bank from among a plurality of signal banks for respective different vehicles.

47. A method according to claim 46 wherein selecting comprises selecting the selected vehicle style image based upon the selected signal bank.

48. A method according to claim 46 wherein selecting comprises selecting the selected vehicle style image based upon at least one transmission from the controller.
